(19) United States
(12) Patent Application Publication
(10) Pub. No.: US 2009/0299865 A1
(43) Pub. Date: Dec. 3, 2009

(54) Method and system for making and managing purchases

(76) Inventor: Lauren Budgen, Geneva, IL (US)

Correspondence Address: STEPTOE & JOHNSON LLP, 1330 CONNECTICUT AVENUE, N.W., WASHINGTON, DC, 20036, US

(21) Appl. No.: 12/431,008

(22) Filed: Apr. 28, 2009

Related U.S. Application Data
(60) Provisional application No. 61/048,450, filed on Apr. 28, 2008.
(60) Provisional application No. 61/048,456, filed on Apr. 28, 2008.

(51) Int. Cl. G06Q 20/00; G06Q 10/00; G06Q 30/00; G07F 19/00

(52) U.S. Cl. 705/17; 705/30; 705/18; 705/26; 235/379

(57) ABSTRACT

A method and system for storing purchase information are presented. A consumer sets up a transaction management account to electronically receive information regarding purchases. The customer provides information regarding the management account to a transaction terminal and makes a purchase. The vendor then electronically sends a receipt to the management account, where purchase information can be managed by the consumer. The management account may be associated with multiple financial accounts, so that when the consumer makes a purchase, information regarding the financial accounts may be provided to the consumer. The consumer can then choose an account to use to complete the purchase.

### CROSS-REFERENCE TO RELATED APPLICATIONS

This application claims priority to U.S. Provisional Application No. 61/048,450 filed Apr. 28, 2008 and U.S. Provisional Application No. 61/048,456 filed Apr. 28, 2008, each of which is incorporated by reference in its entirety.

### BACKGROUND

The present invention relates to a method and system for making a purchase and storing information regarding the purchase in an account.

Consumers can have more flexibility than ever before when making purchases. Most land-based vendors can accept cash, various credit cards, checks, and debit cards. Cash can be convenient because it is accepted everywhere and it is easy to limit purchases by only carrying a certain amount of cash. Credit cards can provide statements showing how much is spent each month on various items. They also can offer cash rewards, redeemable points, or travel miles. Credit cards may also be used to purchase expensive items and spread out the payments over time. Debit cards can be easy to use and may not require a signature to make purchases. And some consumers can prefer to pay with checks to keep track of where money is spent. Many consumers can make purchases using more than one of the methods above in any given month.

Consumers also can have flexibility when making purchases online. Most online vendors can accept credit and debit cards, and services such as Paypal™ allow consumers to use funds from checking accounts to pay for purchases.

Some consumers have multiple credit card accounts, with each account possibly providing certain bonus rewards at certain vendors. For example, a consumer may use a credit card sponsored by a fuel company to get cash back on fuel purchases. The same consumer may use a different credit card at a grocery store to get mileage credits with an airline.

Online checking and savings accounts often can provide interest rates preferable to land-based accounts, but do not provide paper checks for purchases. For example, a consumer may keep a small amount of money in a land-based checking account for some purchases, and another amount of money in an interest-bearing online checking account for paying bills and making online purchases.

Keeping track of purchases using different payment methods and payment accounts can be confusing. A consumer may overdraw an account accidentally when making purchases from numerous accounts without real-time account balance information. Also, transaction information spread over many types of accounts can be difficult to organize, making it difficult to figure out how much money is spent on what and where.

Land-based vendors typically provide paper receipts, but they come in various shapes, are often difficult to read, and are easy to lose. Occasionally vendors fail to provide receipts for purchases. Online vendors can provide electronic receipts, but they typically are printed out on large sheets of paper for record-keeping. And many vendors provide coupons, rebates, or warrantees, often on receipt paper. This paper can be a hassle to store and may be easily misplaced.

Computers can reduce the amount of paper used to keep records and make purchases by allowing users to store information electronically. Some computer programs can allow users to keep track of various types of financial accounts electronically. These let consumers can keep track of account balances in various accounts to avoid spending over a consumer's budget or account balance. But a consumer must be near a computer to use these programs. If a consumer forgets to check an account balance, or if a co-account holder makes a purchase using the account after the consumer has checked the balance, the consumer may still over-draw an account or exceed a budget.

Also, in programs that keep track of various accounts, cash purchases typically require the consumer to enter purchase information manually, which may be time-consuming.

### SUMMARY

A system and method can organize a variety of accounts and transaction information so that a consumer can access and maintain information about accounts and transactions in a way that can allow the user to select an account to be used for a financial transaction at the time of purchase. Also, a system and method can keep track of purchase information in a centralized location, so that information regarding financial transactions using various accounts and cash can be accessed from a centralized account. One advantage of the system and method is that it can provide a method and apparatus for organizing the consumer's receipt or the retailer's receipt, or both, from purchases using various financial accounts and cash. The system and method also can allow a consumer to view information about various financial accounts, and select a desired account before making a purchase.

In one aspect, a method for conducting a transaction includes receiving information from a purchaser for a first transaction management account at a transaction terminal at a vending location. A financial transaction can then be conducted, and information about the transaction can be electronically sent from the transaction terminal to the first transaction management account after completion of the transaction with the purchaser.

In another aspect, the information for the first transaction management account may be received from an RFID chip, a barcode, a magnetic strip, a manual key entry, smart chip, or a similar device. The device used to provide information for the first transaction account may be purchased from a vendor and preferably may be a different card or device than a credit or debit card. Preferably, the card or device may only be associated with the first transaction management account.

In another aspect, the financial transaction may be a purchase or a return. In yet another aspect, the information about the transaction may include a transaction amount, date, time, item(s) purchased, or payment method.

According to another aspect, the vending location may be a kiosk, a store, a restaurant, a lodging location, a gas station, or a services-provider location. In yet another aspect, the information about the transaction may be accessible from an electronic device other than the transaction terminal. In yet another aspect, at least two financial accounts can be associated with the first transaction management account, and financial information for financial transactions using the at least two financial accounts can be viewable from an electronic device or from the transaction terminal by accessing the first transaction management account.

In another aspect, the transaction terminal may be a point-of-sale terminal. In another aspect, the vendor location may be the Internet.

According to another aspect, a method for purchasing includes establishing a first transaction management account to receive information about a transaction from a vendor, and using an electronic device to access the first transaction management account and access information regarding the financial transaction. The first transaction management account can store and maintain information regarding a plurality of transactions regardless of payment method or location of the transaction. The information may include, but is not limited to, transaction receipts, manufacturer and retailer coupons, warranties, rebates, point-of-sale promotions, and other special incentives.

According to another aspect, a system for storing financial information includes a first transaction management account for storing and maintaining information regarding a plurality of transactions, and a transaction module at a vendor location for receiving information associated with the first transaction management account and transmitting information regarding a transaction to the first transaction management account. The information in the first transaction management account can be viewable from an electronic device other than the transaction module, and the first transaction management account can be configured to store information regarding transactions involving a sale or return of merchandise.

In another aspect, the transaction module may be for conducting a financial transaction before transmitting information regarding the transaction to the first transaction management account. In another aspect, the financial transaction may include a transfer of any of cash, a check, a debit card, a credit card, and an electronic funds transfer.

According to another aspect, a method for making a purchase can include obtaining data at a transaction terminal for a first transaction management account to obtain information regarding a plurality of financial accounts at a vending location, displaying information regarding the plurality of financial accounts on the transaction terminal, waiting for an input at the transaction terminal corresponding to at least one of the financial accounts, receiving an input at the transaction terminal corresponding to at least one of the financial accounts, and selecting one of the financial accounts to conduct the financial transaction.

In another aspect, at least one of the plurality of financial accounts may be a credit card account, a checking account, a debit account or a savings account. In another aspect, the at least one of the plurality of financial accounts may include a combination of any of a plurality of credit card accounts, a plurality of checking accounts, or a plurality of savings accounts. In another aspect, the transaction terminal may be a computer with access to the internet, a PDA, or a cell phone.

According to another aspect, a method for conducting a financial transaction comprises inputting account data into a transaction terminal at a vendor location. The account data can be for accessing a first transaction management account, and the first transaction management account is for obtaining data for a plurality of financial accounts and displaying the data for the plurality of financial accounts on the transaction terminal. The method further includes selecting at least one of the financial accounts displayed on the transaction terminal to complete a financial transaction.

According to another aspect, a system for making a purchase may include the first transaction management account being associated with a plurality of financial accounts, where the transaction module is for receiving information corresponding to the first transaction management account, accessing the first transaction management account, displaying information for the plurality financial accounts based on the access to the first transaction management account, receiving an input corresponding to at least one of the financial accounts, and conducting a financial transaction between the transaction terminal and the at least one financial account based on the input.

In another aspect, the first transaction management account may contain information associated with the financial account. In yet another aspect, the financial accounts may be associated with financial institutions, and the first transaction management account may be configured to access the financial institutions to receive information regarding the financial accounts.

Additional aspects and advantages are set forth in part in the description which follows and, in part, will be obvious from the description, or may be learned by practice of the concepts described herein.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an illustration of one embodiment in which a transaction management account is set up by a consumer to receive purchase information;

FIG. 2 is an illustration of a sample screenshot with financial transaction information;

FIG. 3 is an illustration of an embodiment in which a financial transaction takes place between an online vendor and a consumer;

FIGS. 4A and 4B are illustrations of transaction terminals or modules;

FIG. 5 is a flow diagram of a sample transaction; and

FIG. 6 is an illustration of a sample screen shot where the financial transaction information includes access to a coupon and warranty information.

### DETAILED DESCRIPTION OF THE PREFERRED EMBODIMENTS

A preferred method is described here using a purchase as an example. According to this preferred method, a vendor receives information from a purchaser regarding a financial management account. Upon completing the purchase, information about the purchase can be electronically sent from the vendor to the management account.

Financial accounts may be linked to the management account for additional convenience. In such a case, a method for making a purchase can include obtaining information regarding a plurality of financial accounts from the management account. This information may be obtained from a membership card, for example, although other devices may be used to provide the information. The information may then be displayed on the transaction terminal. The terminal waits for an input to at least one of the financial accounts. The input corresponds to a selection of an account to use in the purchase. Upon receiving such an input, the purchase is made from the selected account.

In a system according to a preferred embodiment, a consumer could see the account balances of the financial accounts associated with the management account. The consumer could select an appropriate account, based on the account type and account balances, which would allow the consumer to avoid any unnecessary fees or penalties from the financial institutions.

In a system according to a preferred embodiment, a transaction management account stores and maintains information regarding a plurality of transactions. A transaction module at a vendor location receives information associated with the first transaction management account when a customer makes a purchase. The module then transmits information regarding the transaction to the management account. This information may include coupons, rebates, and other special incentives recognized by the management account or the associated management account card or device. This information can be viewable from an electronic device other than the transaction module, and the first transaction management account can be configured to store information regarding transactions involving a sale or return of merchandise.

The system and methods are not limited to use with consumers. Vendors are generally required to keep receipts for a given amount of time, and most receipts are kept in paper form. But if a vendor needs to look at old receipts, it may be difficult to find information on receipts and can be expensive to store them. Also, vendors using paper receipts cannot conveniently use the receipts to track customer purchase information. For example, if a vendor wants to know which items are popular in a certain area or zip code, paper receipts are an expensive and inconvenient way to obtain the information.

By making an electronic record of the receipt at the time of purchase, a vendor may store receipts electronically rather than printing paper copies. A vendor may use electronically stored receipts as a market research tool by sorting the electrically stored information by item purchased, price, geography, or any other criterion. Also, the electronically stored information may include rebate forms, coupons, and warranty information. This may save both the vendor and the customer time, paper, and money, because the vendor need not print out paper warranties, and the customer can access the warranty electronically from any location.

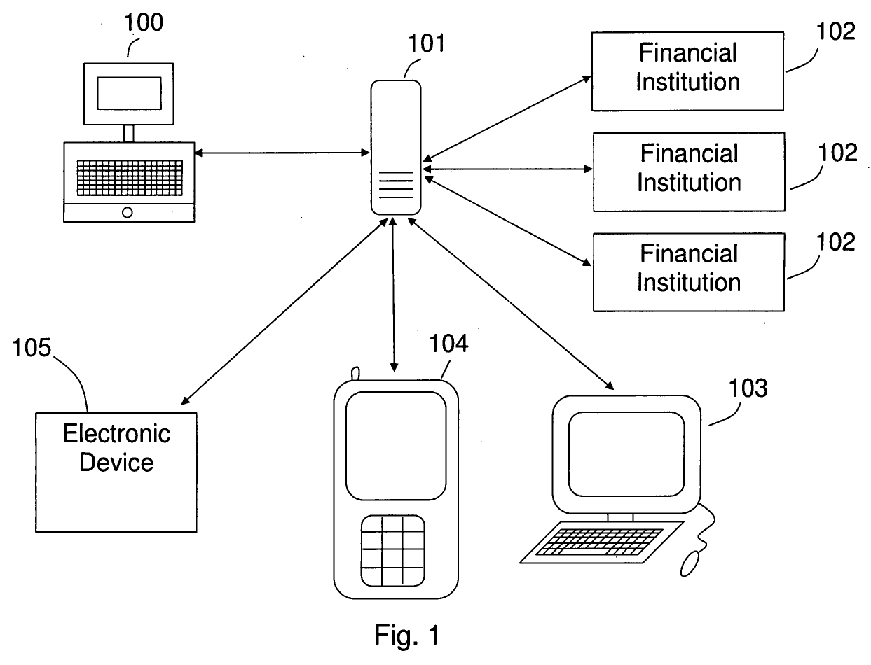

FIG. 1 is a diagram showing the architecture of the method and apparatus for storing financial information and making a purchase. A transaction management account may be set up on a personal computer 103 or any other electronic device with access to the Internet, or to the server 101 hosting the transaction management account. For example, the transaction management account may be set up from a cell phone 104, a transaction terminal or module 100, or from any other electronic device 105. A consumer may also fill in information on a paper form and have an employee of a services company or other agent enter the information into an electronic device to set up the account.

The account may be connected to a financial institution 102, or to multiple financial institutions. For example, the consumer may enter information for credit card accounts, checking accounts, savings accounts, or any other financial account.

After the consumer enters information for the financial accounts, the transaction management account is able to access the financial accounts to retrieve account information such as account balances, transaction dates, transaction types, and credit balances.

After setting up the transaction management account, the consumer is able to make purchases or returns and receive information regarding the financial transaction from any device with access to the Internet, or with access to the server 101 that hosts the financial management account. The transaction account may receive this information either in real-time or through a delayed batched format depending upon the business practice of the retail/vendor location. A customer may access the account from a personal computer 103, a cell phone 104, or any other electronic device 105.

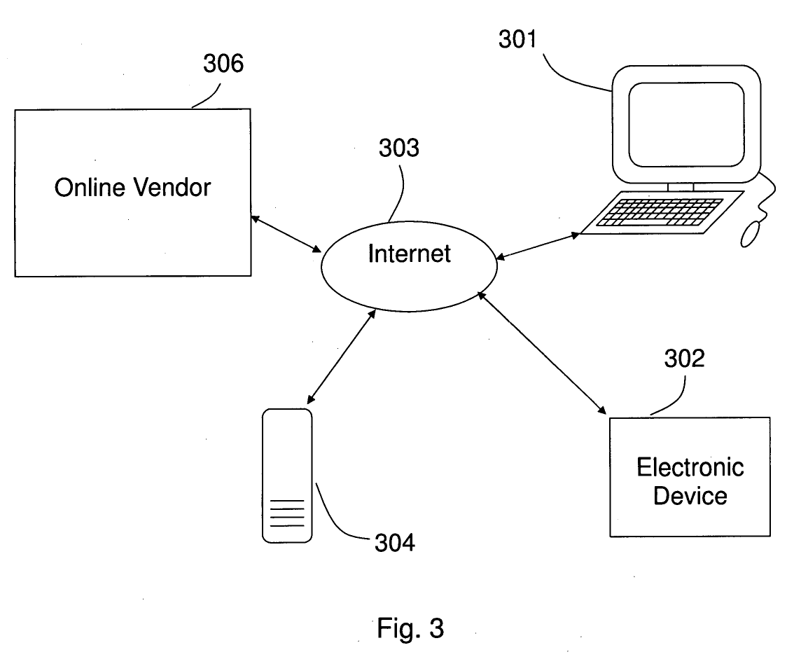

A consumer can shop at any store, vendor, kiosk, or any location where services are provided, such as dining services, auto maintenance centers, and hotels. At the time of purchase, the consumer enters information into a transaction terminal 100. The information directs the transaction terminal to access the transaction management account. In FIG. 1, the transaction terminal 100 is represented by a register, for example. The transaction terminal may also be a personal computer, if shopping online. FIG. 3 shows an example of an online purchase. The consumer may also enter the information into a module near a register, kiosk, or other conventional point of sale device.

Although FIG. 1 uses a register as an example of a transaction terminal, the terminal is not limited to any single device. For example, an electronic scanner, keypad, radio frequency detector, or other data-receiving device may receive data and transfer the data to a separate computer or network which connects to the transaction maintenance account via a modem, Ethernet, or other means to connect to server 101.

The transaction terminal may receive the information regarding the transaction management account by any means including manual entry, barcode, RFID, and magnetic strip. For example, a barcode reader used to scan products may also be programmed to scan a barcode containing transaction management account information. The consumer then performs a transaction by either purchasing or returning merchandise. The consumer can pay for the transaction using any financial account, such as a checking or credit card account, or by paying with cash or a check. The transaction terminal then sends an electronic receipt to the transaction management account, making a paper copy of a receipt unnecessary.

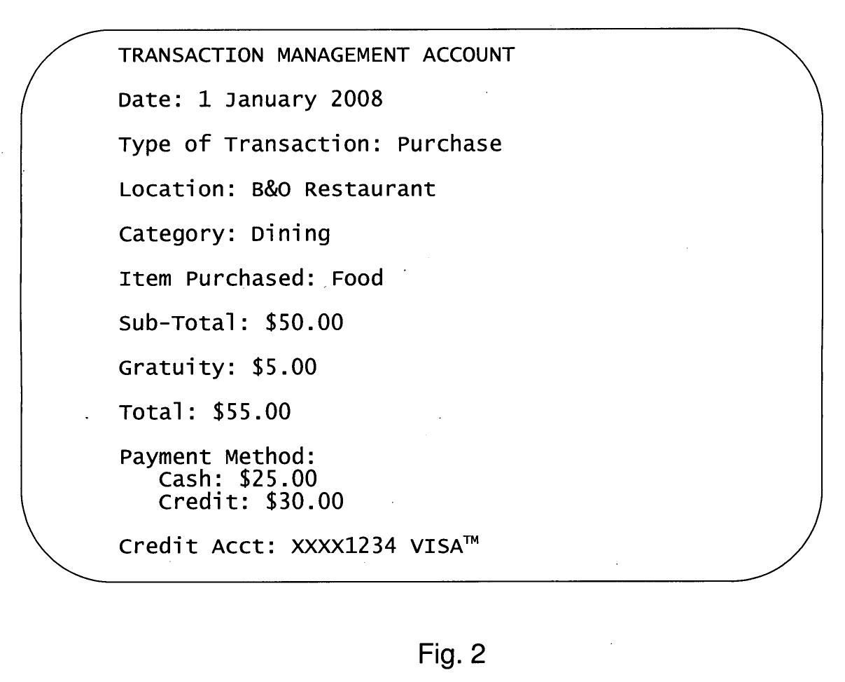

The electronic receipt may be a copy of an actual paper receipt, or information about the transaction in any form that can be transferred electronically. FIG. 2 shows a sample of financial information that may appear on the electronic receipt that can be accessed from an electronic device, such as a personal computer. Preferably, the electronic receipt indicates the amount, date, itemized purchase details, and type of transaction. The receipt may also show what was purchased, the payment method, the account number used to purchase the goods or services, the location of the purchase, or any other information about the purchase. The consumer may then access the receipt from any electronic device with access to the Internet or the server 101 hosting the transaction management account.

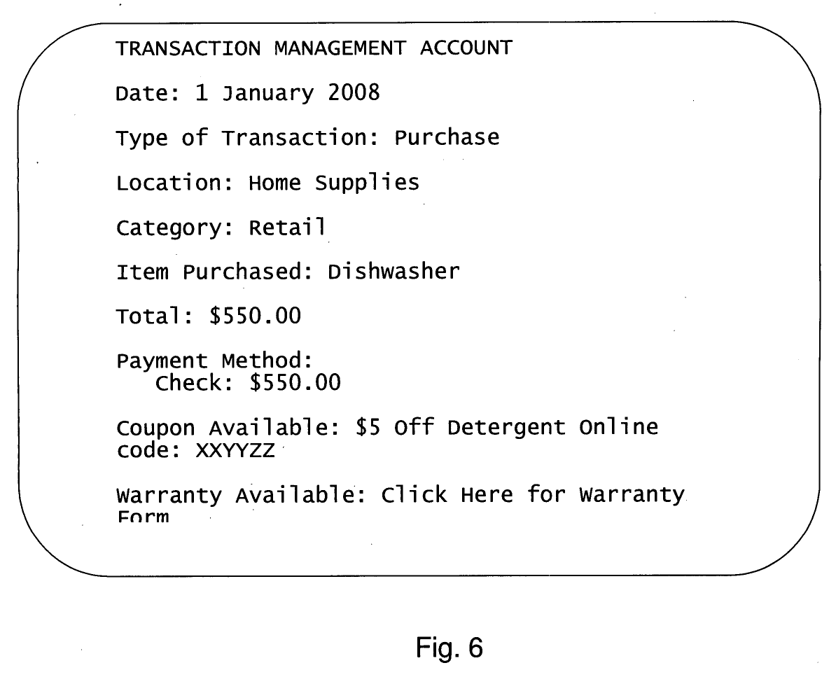

FIG. 6 shows a sample of financial information including a coupon and warranty information. The coupon and warranty information may be embedded with the electronic receipt of the transaction, or the transaction may provide links to the locations of the coupon and warranty information.

The transaction management account may also give consumers the option of receiving a physical receipt as well as an electronic copy of the receipt. A consumer may access the management account to select various receipt options. For example, the consumer may decide to receive paper receipts and electronic receipts for some types of purchases, such as at gas stations, and only electronic receipts for other purchases, such as at grocery stores.

Consumers can shop at any number of stores and pay by any payment method. They will not need to keep any paper receipts, and will be able to track all their purchases and returns from any location by accessing the transaction management account.

In another embodiment, when consumers provide information regarding the transaction management account, the management account accesses a number of financial institutions 102 associated with the account. The financial institutions 102 are ones where the consumers have accounts such as checking or credit card accounts. As shown in FIG. 3, the transaction management account then provides information 301 regarding the financial accounts to the transaction terminal 100. The transaction terminal 100 displays information about the financial accounts and prompts the consumer to select a financial account to use in the transaction. Preferably, the consumer can see the names and account balances of each of the financial accounts. The consumer may also be able to enable or disable financial accounts in the transaction management account to prevent certain accounts from appearing at a transaction terminal 100.

FIG. 3 shows an example of an online purchase. An online transaction is identical to the in-store transaction, except online vendors generally cannot accept cash. When making a purchase online, the consumer's personal computer 301 acts as the transaction terminal. Any other device 302 with access to the Internet may be used. For example, a consumer may make a purchase over their cell phone. The consumer enters information into the transaction terminal, 301, 302 which directs the transaction terminal 301, 302 to the transaction management account. This account may be hosted by a server 304, or any other device that stores the electronic information accessed by the transaction terminal 301, 302. Preferably, the transaction terminal communicates with the online vendor 306 and with the transaction management account server 304 via the Internet 303.

After entering the transaction management account information, the consumer makes a purchase from the online vendor 306. As with land-based vendors, the transaction management account may provide information to the transaction terminal 301, 302 regarding a number of financial institutions. The consumer may select a financial institution to use to perform the transaction. An electronic receipt of the transaction is then sent to the transaction management account, and the consumer does not have to print out a receipt or save a receipt to their computer 301.

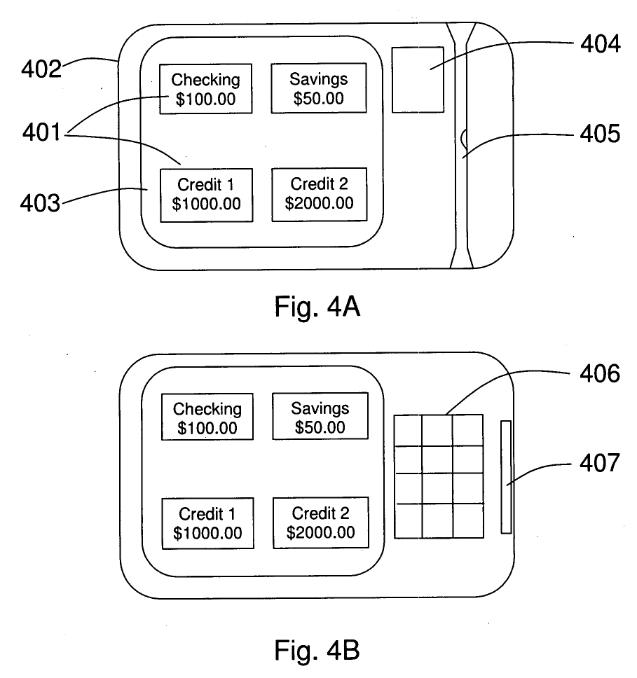

FIGS. 4A and 4B illustrate examples of transaction modules 402 which may be used to enter transaction management account information and display financial account information 401. In FIG. 4A, the module 402 has an RFID reader 404 and a card slider 405 for a card with a magnetic strip. When information regarding the transaction management account is received, the module 402 displays financial account information on the screen 403. Preferably, the screen 403 is a touch-screen, but adjacent buttons or other means of selecting a financial account may also be used. Once a financial account is selected, the customer makes a purchase, and an electronic receipt is sent to the transaction management account. A copy of the receipt may also be printed out or displayed on the module screen 403 or a nearby screen.

A customer may also use cash, a check, or a credit card at the vending location. In such a case, the customer would not select a financial account, but an electronic receipt would still be sent to the transaction management account.

FIG. 4B shows a module 402 with a keypad 406 and barcode reader 407 for entering information into the transaction module 402 to transmit to the transaction management account. Although an RFID reader 404, magnetic strip reader 405, keypad 406, and barcode reader 307 were illustrated, any means of entering information can be used to direct the transaction module 302 to the transaction management account. Similarly, the transaction module 302 can take any form, such as a screenless module, a cash register or register system, or any electronic device with a means to receive information and transmit it electronically.

For example, a customer could use a telephone to make a purchase and orally transmit information to an operator, salesperson, or computer which would direct the vendor to access the transaction management account. The customer could select an account to use in the transaction based on audible cues and receive an electronic receipt in the transaction management account.

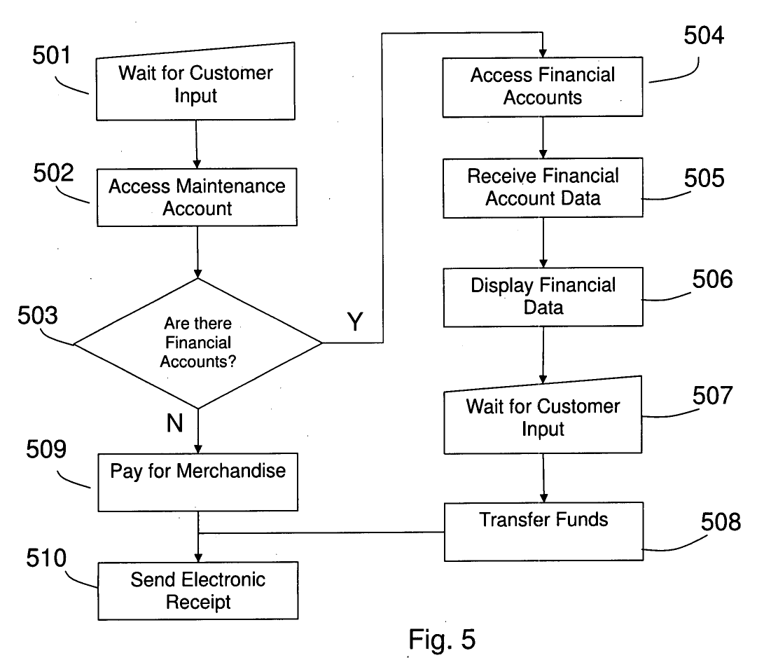

FIG. 5 is a flow chart illustrating a method. First, a transaction terminal waits to receive an input from a customer 501. Upon receiving an input directing the transaction terminal to the transaction management account, the terminal accesses the account 502. If the account is associated with financial accounts 503, the transaction management account may access those accounts to provide information to the transaction terminal 504. Alternatively, the account may direct the transaction terminal's system to access the financial accounts. Information regarding the accounts is then transmitted to the transaction terminal 505. Information from the financial accounts may then be displayed at the vendor location 506, preferably on the transaction terminal. The transaction terminal then waits to receive a customer input, selecting an account to use to complete the transaction 507. The funds are then transferred from the selected account to the vendor to pay for the purchase 508. If no financial accounts are associated with the transaction management account or if access to the accounts is disabled, the purchase may be completed by any ordinary means, such as with cash, credit card, check, debit card, or electronic funds transfer 509. An electronic receipt is then transmitted to the transaction management account 510. The electronic receipt is submitted regardless of payment type and regardless of whether financial accounts are associated with the management account.

An example of a purchase follows. A customer brings an item to be purchased to a register. The cashier scans the item, and a total purchase amount is calculated. The customer may then enter the management account information by swiping a card associated with the account through a magnetic reader on a sales module. The computer system connected to the sales module then communicates with the management account through a network such as the Internet. The customer then pays for the item with cash, credit card, or any other form of payment accepted by the vendor, and an electronic receipt for the purchase is sent to the management account. The customer can then go to another store, make another purchase using a different payment method, and an electronic receipt will be sent to the same management account.

Although in this example, the customer swiped the management account card after the item was scanned, the card may be swiped either before or after the merchandise is scanned. And while the customer used a different payment method in a different store in the example, a customer may use the same payment method, or even a different type of the same method, such as two different credit cards.

If financial accounts are associated with the management account, then when the customer swipes the management account card and the sales system accesses the management account, the financial account information will be sent to the sales module. The module may then display account information and allow the customer to choose an account with which they will purchase the item. For example, the customer may have a credit card account with a $1,000.00 balance and a checking account with a $50.00 balance. The customer may then select which account to use to purchase the item, and the sales module completes the purchase using the selected account.

Returning an item works in the same manner as purchasing an item. For example, the customer might place a barcode in front of the merchandise scanner, which would retrieve information about the management account. The sales system can then access the management account through a network such as the Internet. The customer might present the cashier with the credit card used to make the purchase. The cashier enters the information about the item to be returned, and the amount of the refund would be refunded to the credit card or paid in cash to the customer, if the item was purchased with cash. A receipt for the refund could be sent to the management account, or the original purchase receipt in the management account may be electronically modified to reflect the item's return.

If financial accounts were associated with the management account, the amount of the refund could be sent directly to the financial accounts, without the need to show the cashier a credit or debit card.

Other features and advantages can be found in the claims.

What is claimed is:

1. A method for conducting a transaction, comprising:
receiving information for a first transaction management account at a transaction terminal at a vending location from a purchaser,
conducting a financial transaction, and
electronically sending information about the transaction from the transaction terminal to the first transaction management account after completion of the transaction with the purchaser.

2. The method according to claim 1, wherein the information for the first transaction management account is received from an RFID chip, a barcode, a magnetic strip, or a manual key entry.

3. The method according to claim 1, wherein the financial transaction is a purchase or a return.

4. The method according to claim 1, wherein the information about the transaction includes a transaction amount, date, time, item purchased, or payment method.

5. The method according to claim 1, wherein the vending location is a kiosk, a store, a restaurant, a lodging location, a gas station, a services-provider location, or the Internet.

6. The method according to claim 1, wherein the information about the transaction is accessible from an electronic device other than the transaction terminal.

7. The method according to claim 1, wherein at least two financial accounts are associated with the first transaction management account, and financial information for financial transactions using the at least two financial accounts are viewable from an electronic device or from the transaction terminal by accessing the first transaction management account.

8. The method according to claim 1, wherein the transaction terminal is a point-of-sale terminal.

9. A method for purchasing, comprising:
establishing a first transaction management account to receive information about a transaction from a vendor, and
using an electronic device to access the first transaction management account and access information regarding the financial transaction,
wherein the first transaction management account stores and maintains information regarding a plurality of transactions regardless of payment method or location of the transaction.

10. The method according to claim 9, wherein the financial transaction is a purchase or a return.

11. The method according to claim 9, wherein the information about the transaction includes a transaction amount, date, time, item purchased, or payment method.

12. The method according to claim 9, wherein at least two financial accounts are associated with the first transaction management account, and financial information for financial transactions using the at least two financial accounts are viewable from an electronic device by accessing the first transaction management account.

13. A system for storing financial information, comprising:
a first transaction management account for storing and maintaining information regarding a plurality of transactions,
a transaction module at a vendor location for receiving information associated with the first transaction management account, and transmitting information regarding a transaction to the first transaction management account,
wherein the information in the first transaction management account is viewable from an electronic device other than the transaction module, and
the first transaction management account is configured to store information regarding transactions involving a sale or return of merchandise.

14. The system of claim 13, wherein the transaction module is for conducting a financial transaction before transmitting information regarding the transaction to the first transaction management account.

15. The system of claim 13, wherein the financial transaction includes a transfer of any of cash, a check, a debit card, a credit card, and an electronic funds transfer.

16. The system according to claim 13, wherein the information for the first transaction management account is received from an RFID chip, a barcode, a magnetic strip, or a manual key entry.

17. The system according to claim 13, wherein the financial transaction is a purchase or a return.

18. The system according to claim 13, wherein the information regarding the transaction includes a transaction amount, date, time, item purchased, or payment method.

19. The system according to claim 13, wherein the vendor location is a kiosk, a store, a restaurant, a lodging location, a gas station, a services-provider location, or the Internet.

20. The system according to claim 13, wherein at least two financial accounts are associated with the first transaction management account, and financial information for financial transactions using the at least two financial accounts are viewable from an electronic device or from the transaction module by accessing the first transaction management account.

21. The method of claim 1, further comprising:
obtaining data at a transaction terminal for a first transaction management account to obtain information regarding a plurality of financial accounts at a vending location,
displaying information regarding the plurality of financial accounts on the transaction terminal,
waiting for an input at the transaction terminal corresponding to at least one of the financial accounts,
receiving an input at the transaction terminal corresponding to at least one of the financial accounts, and
selecting one of the financial accounts to conduct the financial transaction.

22. The method of claim 21, wherein the displayed information from the plurality of financial accounts is at least one of an account name, a financial institution name, a credit balance, or an account balance.

23. The method of claim 21, wherein the at least one of the plurality of financial accounts comprises a combination of any of a plurality of credit card accounts, a plurality of checking accounts, or a plurality of savings accounts.

24. The system of claim 13, wherein the first transaction management account is associated with a plurality of financial accounts, and
the transaction module is for receiving information corresponding to the first transaction management account, accessing the first transaction management account, displaying information for the plurality financial accounts based on the access to the first transaction management account, receiving an input corresponding to at least one of the financial accounts, and conducting a financial transaction between the transaction terminal and the at least one financial account based on the input.

25. The method according to claim 1, wherein the information about the transaction includes at least one of warranty information, manufacturer or retailer coupons, point-of-sale promotions, or special incentives.
